(19) United States
(12) Patent Application Publication
(10) Pub. No.: US 2022/0406170 A1
(43) Pub. Date: Dec. 22, 2022

(54) Metering Data Remote Collection Unit Changing a Data Sending Time to a Server according to the Communication Sensitivity

(71) Applicant: IS Technologies Co., Ltd, Incheon (KR)

(72) Inventor: Gab Sang Yoo, Incheon (KR)

(21) Appl. No.: 17/253,699

(22) PCT Filed: Dec. 8, 2020
(86) PCT No.: PCT/KR2020/017856

§ 371 Date: Dec. 18, 2020

(30) Foreign Application Priority Data
Dec. 8, 2020 (KR) 10-2020-0170077

(51) Int. Cl. G08C 17/02

(52) U.S. Cl. CPC G08C 17/02; G08C 2201/12

(57) ABSTRACT

The present invention relates to metering data remote collection technology. It is an object of the present invention to provide a remote collection unit configured such that battery consumption is reduced so as to endure until the term of use elapses. The remote collection unit periodically collects metering data at a first time interval and stores the collected metering data in a memory, and transmits metering data periodically collected and stored at a second time interval, at least from after the previous point in time of transmission to the current point in time of transmission, to a central center server over a wireless communication network, wherein transmission at the current point in time of transmission is performed after whether to perform the transmission is decided depending on communication sensitivity of the wireless communication network.

### TECHNICAL FIELD

The present invention relates to metering data remote collection technology.

### BACKGROUND ART

Illustratively, in meter-reading the use amount of gas, electricity, tap water, etc., a meter reader directly checked the same with his/her naked eye and recorded the same in the past. In recent years, however, the switchover to remote meter reading has been rapidly occurred due to development of communication and sensor technology and an increase in personnel expenses.

A remote collection unit receives metering information from a meter and transmits the received metering information to an external server or concentrator through a communication module.

The remote collection unit reads metering data of the meter at a predetermined time interval, i.e. a predetermined metering period, and stores the read metering data in a memory.

In addition, the remote collection unit transmits the metering data to the server over a communication network at a predetermined time interval, i.e. a transmission period.

In general, since the metering period is shorter than the transmission period, a plurality of metering data collected from the previous points in time of transmission to the current point in time of transmission are transmitted to the server together at the current point in time of transmission.

Illustratively, the metering period may be 1 hour, and the transmission period may be 6 hours.

In this case, therefore, 6 metering data read during one transmission period, i.e. for 6 hours, are simultaneously transmitted to the server.

Meanwhile, the remote collection unit generally has a battery built therein, and the predetermined lifespan (e.g. 8 years) of the remote collection unit must be satisfied using only the battery initially built therein. Consequently, it is necessary to design the remote collection unit so as to minimize the use of power of the battery.

In order to satisfy the lifespan of the remote collection unit, the remote collection unit is switched to a sleep mode in order to minimize use of the battery except for the time of collecting metering data or the time of transmitting the data to the outside.

Battery consumption is high at the time of communication; about 80% of the battery is consumed for external communication.

Particularly, in the past, when transmitting metering data to an external apparatus, such as the server, the remote collection unit increases communication power in order to perform communication in the state in which communication sensitivity is low. As a result, power consumption is higher than the case in which communication sensitivity is high.

In the case in which data transmission is performed in the state in which communication sensitivity is low, battery consumption increases about two-fold or more, whereby the lifespan of the battery may be cut in half or more.

In addition, reduction in communication sensitivity may lead to data transmission failure. In this case, transmission attempts may be continued until transmission at a corresponding point in time is successful, whereby battery consumption greatly increases.

Therefore, there is a need for remote collection technology capable of enduring until the required term of use elapses even in the situation in which communication sensitivity is low. This technology is more and more necessary in a weak wave area, in which communication sensitivity is low.

### DISCLOSURE

### Technical Problem

It is an object of the present invention to provide a remote collection unit configured such that battery consumption is reduced so as to endure until the term of use elapses.

It is another object of the present invention to provide a remote collection unit applicable to a remote water level/flow rate monitoring system, a disaster management system, a flood management system, and a water leakage detection system in addition to remote collection of metering data for gas, tap water, electricity, etc.

It is a further object of the present invention to provide a remote collection unit configured such that excessive battery consumption due to communication failure is reduced, whereby overall battery consumption is reduced.

### Technical Solution

A remote collection unit according to the present invention periodically collects metering data at a first time interval and stores the collected metering data in a memory, and transmits metering data periodically collected and stored at a second time interval, at least from after the previous point in time of transmission to the current point in time of transmission, to a central center server over a wireless communication network, wherein transmission at the current point in time of transmission is performed after whether to perform the transmission is decided depending on communication sensitivity of the wireless communication network.

In at least one embodiment of the present invention, the transmission at the current point in time of transmission may be performed in the case in which the communication sensitivity is equal to or greater than a reference value, and in the case in which the communication sensitivity is less than the reference value, the metering data remote collection unit may reserve the transmission and primarily change the point in time of transmission.

Also, in at least one embodiment of the present invention, the changed point in time may be decided to be behind by the second time interval.

Also, in at least one embodiment of the present invention, in the case in which the transmission is reserved, the metering data remote collection unit may notify the server of the changed point in time.

Also, in at least one embodiment of the present invention, in the case in which the communication sensitivity at the changed point in time is less than the reference value, the metering data remote collection unit may reserve transmission again and may secondarily change the point in time of transmission.

Also, in at least one embodiment of the present invention, in the case in which a number of changes reaches a predetermined value as the result of repetition of the secondary change, the metering data remote collection unit may transmit all metering data accumulated from after the previous point in time of transmission to date to the server even though the communication sensitivity is less than the reference value.

In at least one embodiment of the present invention, the second time interval may be n (n is an integer of two or more) times the first time interval. In the remote collection unit, a processor may be operated at the time of collecting or transmitting data, and in other cases, the remote collection unit may be in a sleep mode in order to reduce battery consumption. Consequently, it is preferable that data collection and transmission be performed together when the processor is operated once, and therefore it is preferable that the second time interval be n (n is an integer of two or more) times the first time interval.

### Advantageous Effects

Since whether to perform transmission to a server is decided depending on communication sensitivity, it is possible to reduce excessive battery consumption of a remote collection unit due to communication failure.

In particular, it is possible to apply a remote metering system even to a weak wave area.

### DESCRIPTION OF DRAWINGS

FIG. 1 is a view showing the construction of a remote metering system including a remote collection unit according to an embodiment of the present invention.

FIG. 2 shows a procedure of a remote collection unit (MDRCU 1) of the remote metering system of FIG. 1 collecting metering data from a meter (M11) and transmitting the collected data to a server.

FIG. 3 illustrates a modification of the procedure of FIG. 2 in the case in which communication sensitivity for transmission from the remote collection unit (MDRCU 1) to the server.

### BEST MODE

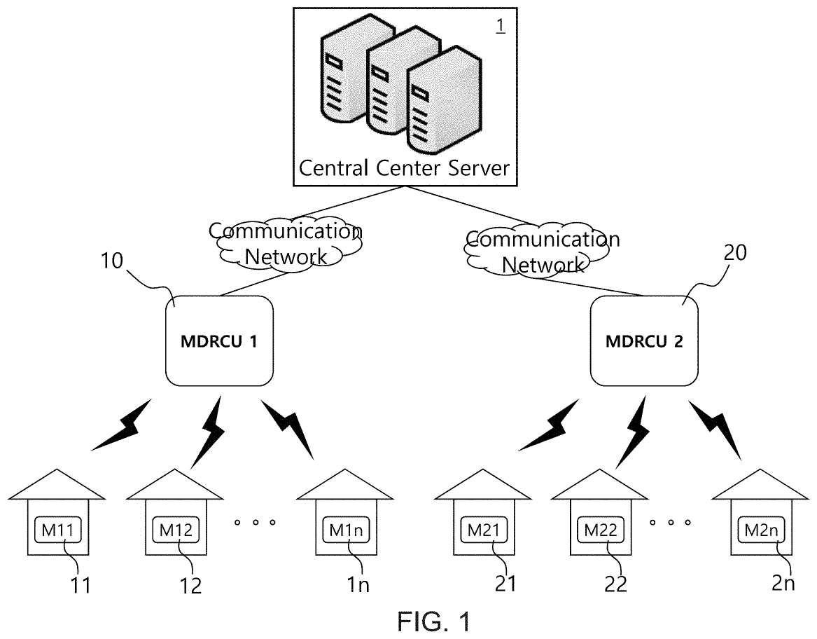

FIG. 1 is a view showing the construction of a remote metering system using remote collection units 10 and 20 according to an embodiment of the present invention.

The remote metering system includes meters 11, 12, . . . , 1n, 21, 22, . . . , 2n (n is an integer), remote collection units 10 and 20, and a central center server 1.

The meters 11, 12, 1n, 21, 22, and 2n measure the use amount of objects to be measured and transmit the same to the remote collection units 10 and 20.

Here, the objects to be measured may be at least one of gas, tap water, electricity, and hot water. Hereinafter, the case in which the objects to be measured are tap water will be described by way of example.

In the case in which the objects to be measured are tap water, the metering units 10 and 20 may be conventional well-known ultrasonic meters 11, 12, 1n, 21, 22, and 2n.

The meters 11, 12, 1n, 21, 22, and 2n may be connected to the remote collection units 10 and 20 in a wired fashion. Alternatively, the meters may be communicatively connected to the remote collection units through wireless communication, preferably short-range wireless communication, in the state of being physically separated from each other.

The short-range wireless communication may be any one of Wireless Local Area Network (WLAN), Bluetooth, Radio Frequency Identification (RFID), ZigBee, Wi-Fi, and Ultra-Wideband (UWB) wireless communication.

Illustratively, the remote collection unit may be integrally formed with the meters 11, 12, 1n, 21, 22, and 2n to constitute ultrasonic meters 11, 12, 1n, 21, 22, and 2n. In this case, each meter integrally contains a remote collection unit.

Alternatively, the meters 11, 12, 1n, 21, 22, and 2n may be installed at water pipes, and the remote collection units 10 and 20 may be electrically connected to the meters 11, 12, 1n, 21, 22, and 2n in order to receive information in the state of being spaced apart therefrom.

Metering data may be acquired together with metering time, and the meters 11, 12, 1n, 21, 22, and 2n may temporarily store the data in built-in memories.

The server 1 is a place at which metering data are finally collected, and may perform appropriate operations using the collected metering data.

Illustratively, the server 1 may be a server 1 that is operated by a profit-making or nonprofit organization that charges consumers for consumption. For example, the server may be a server 1 that is operated by a self-governing body in order to charge for water.

In FIG. 1, the remote collection units 10 and 20 collect metering data from the meters 11, 12, 1n, 21, 22, and 2n, and transmit the collected metering data to the server 1.

The remote collection units 10 and 20 are communicatively connected to the server 1 over a wireless communication network. Illustratively, the wireless communication network may be any one of a satellite communication network, a power line communication network, and a mobile communication network, or may be an Internet of Things (IoT) communication network, such as Long Range (LoRA) or NarrowBand-Internet of Things (NB-IoT).

The remote collection units 10 and 20 periodically collect metering data from the meters 11, 12, 1n, 21, 22, and 2n, and wirelessly transmit the collected metering data to the server 1.

Preferably, the remote collection units 10 and 20 periodically collect metering data from the meters 11, 12, 1n, 21, 22, and 2n during a predetermined time period, store the collected metering data in built-in memories, and wirelessly transmit a predetermined number of stored data to the server 1 at once.

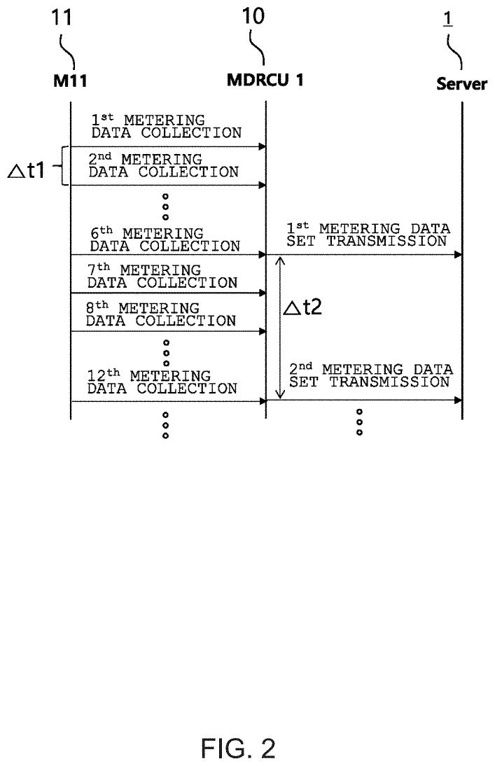

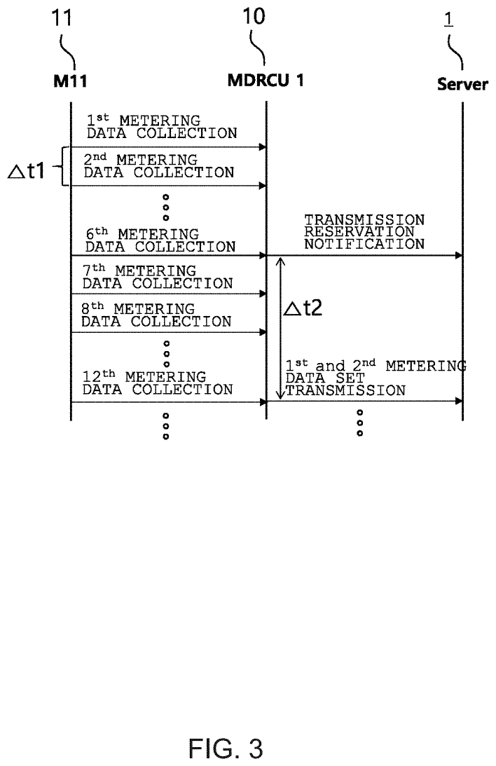

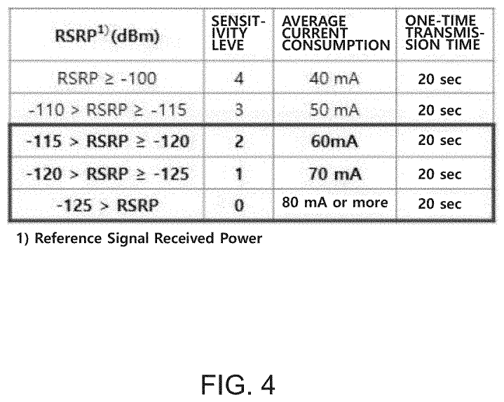

FIGS. 2 and 3 show processes that occur in the meters 11, 12, 1n, 21, 22, and 2n, the remote collection units 10 and 20, and the server 1 in connection with metering data collection.

As shown in FIG. 2, the remote collection units 10 and 20 collect metering data from the meters 11, 12, 1n, 21, 22, and 2n at a first time interval Δt1. The collected data are stored in built-in memories of the remote collection units 10 and 20.

The remote collection units 10 and 20 transmit the collected data to the server 1 at a second time interval Δt2.

In this embodiment, illustratively, the first time interval Δt1 is 1 hour, and the second time interval Δt2 is 6 hours. Consequently, the remote collection units 10 and 20 collect metering data from the meters 11, 12, 1n, 21, 22, and 2n every hour, and transmit the collected data to the server 1 at a 6-hour interval.

In this case, 24 metering data are collected per day, and these data are transmitted to the server 1 by six at a time and four times a day.

Preferably, when data are transmitted from the remote collection units 10 and 20 to the server 1, the server 1 transmits an acknowledgement signal to the remote collection units 10 and 20 in order to acknowledge that the data have been received.

Upon receiving the acknowledgement signal, therefore, the remote collection units 10 and 20 may determine that data transmission has been completed. Upon not receiving the acknowledgement signal, however, the remote collection units 10 and 20 determine that data were lost on the way, and repeatedly transmit data until the remote collection units successfully receive the acknowledgement signal. That is, if transmission fails, data are repeatedly retransmitted, whereby battery consumption greatly increases. Also, in the case in which the communication state is not good, data transmission time may further increase, and battery power may be further consumed in proportion to transmission time.

Also, even in the case in which transmission failure does not occur, the remote collection units 10 and 20 may increase communication power in order to transmit data in the state in which communication sensitivity is low. Such a power increase causes battery consumption. FIG. 4 illustratively shows average current consumption for data transmission based on communication sensitivity. As shown in FIG. 4, the lower the level of communication sensitivity, the higher the magnitude of current necessary for data transmission.

In this embodiment, in order to reduce battery consumption, the remote collection units 10 and 20 perform data transmission depending on communication sensitivity. That is, in the case in which there is no communication failure between the remote collection units 10 and 20 and the server 1, data are transmitted to the server 1 by periods as shown in FIG. 2. In the case in which the communication state is not good, however, data are not transmitted as described above.

In this embodiment, when transmitting data to the server 1, the remote collection units 10 and 20 check communication sensitivity first, and transmit data based on the result thereof.

Here, communication sensitivity may be checked by the remote collection units 10 and 20 themselves, and may be checked using any one of conventional well-known methods. Therefore, a detailed description thereof will be omitted.

FIG. 3 illustrates the procedure in which data are transmitted from the remote collection units 10 and 20 to the server 1 in the case in which communication sensitivity checked by the remote collection units 10 and 20 is less than a reference value.

In FIG. 3, when communication sensitivity is not good, the remote collection units 10 and 20 do not transmit collected data ranging from first metering data to sixth metering data to the server 1 but reserve the collected data. At the same time, the remote collection units transmit a reservation notification signal to the server 1 in order to notify of the above fact.

Preferably, the reservation notification signal reaches the server 1 even in the state in which communication sensitivity is low. It is preferable that capacity of the reservation notification signal be considerably smaller than at least the amount of metering data to be transmitted.

Upon receiving the reservation notification signal, the server 1 may transmit an acknowledgement signal to the remote collection units 10 and 20.

The reserved data are continuously stored in the built-in memories of the remote collection units 10 and 20.

Even after data transmission is reserved, the remote collection units 10 and 20 continuously collect metering data at the first time interval and store the collected metering data in the memory.

When another second time interval elapses again after reservation, communication sensitivity is checked, and when communication sensitivity is equal to or greater than the reference value, all of the data collected in the meantime, including the reserved data, are transmitted to the server 1.

In the case in which communication sensitivity is less than the reference value, on the other hand, transmission of the collected data is reserved once again. In this case, therefore, transmission of data ranging from the first metering data to twelfth metering data is reserved, and the data are stored in the memories of the remote collection units 10 and 20.

Transmission reservation due to low communication sensitivity is preferably performed only up to a predetermined number of times or before a predetermined point in time. Preferably, in the case in which the second time interval is 6 hours, transmission is reserved only up to three times, and transmission is performed at the fourth trial even in the case in which communication sensitivity is low. That is, in this case, transmission reservation time does not exceed 24 hours.

The reason that transmission reservation is limited as described above is that it is necessary to prevent loss of data due to reservation.

In addition, since an increase in the number of times of transmission reservation requires large capacity of each of the built-in memories of the remote collection units 10 and 20, it is preferable to limit the number of times of transmission reservation.

In addition, it is necessary to manage metering data together with time read from the meters. When transmission reservation time exceeds 24 hours, meter reading date as well as time must be recorded and stored for each of the metering data. In the case in which transmission reservation time exceeds 24 hours, therefore, the amount of data to save is increased, since date data must be included, and therefore necessary memory capacity is also increased.

Although the remote metering system for tap water has been described above as an embodiment, the present invention is not limited thereto. As previously described, the present invention is applicable to electricity, hot water, or gas in addition to tap water.

In addition, the present invention is applicable to a flood management system or a water leakage detection system.

For example, the flood management system may include the remote collection units 10 and 20 according to the present invention, wherein the remote collection units periodically receive metering data from water level meters 11, 12, 1n, 21, 22, and 2n configured to measure the level of a river, etc. and transmit the collected metering data to the server 1 such that the data are utilized for blood warning.

In addition, the remote collection units 10 and 20 according to the present invention are also applicable to a water leakage detection system that detects leakage of water from water pipes in each home or intermediate pipes configured to supply tap water to each home

In addition, the remote collection units 10 and 20 according to the present invention are also applicable to a remote water level/flow rate monitoring system, a disaster management system, and the like.

### DESCRIPTION OF REFERENCE SYMBOLS

1: Server 10, 20: Remote collection units
11, 12, 1n, 21, 22, 2n: Meters

1. A metering data remote collection unit for transmitting metering data depending on communication sensitivity, the metering data remote collection unit being configured:
to periodically collect metering data at a first time interval and to store the collected metering data in a memory; and
to transmit metering data periodically collected and stored at a second time interval, at least from after a previous point in time of transmission to a current point in time of transmission, to a central center server over a wireless communication network, wherein
transmission at the current point in time of transmission is performed after whether to perform the transmission is decided depending on communication sensitivity of the wireless communication network.

2. The metering data remote collection unit according to claim 1, wherein
the transmission at the current point in time of transmission is performed in a case in which the communication sensitivity is equal to or greater than a reference value, and
in a case in which the communication sensitivity is less than the reference value, the metering data remote collection unit reserves the transmission and primarily changes the point in time of transmission.

3. The metering data remote collection unit according to claim 2, wherein the changed point in time is decided to be behind by the second time interval.

4. The metering data remote collection unit according to claim 2, wherein, in a case in which the transmission is reserved, the metering data remote collection unit notifies the server of the changed point in time.

5. The metering data remote collection unit according to claim 2, wherein, in a case in which the communication sensitivity at the changed point in time is less than the reference value, the metering data remote collection unit reserves the transmission again and secondarily changes the point in time of transmission.

6. The metering data remote collection unit according to claim 5, wherein in a case in which a number of changes reaches a predetermined value as a result of repetition of the secondary change, the metering data remote collection unit transmits all metering data accumulated from after the previous point in time of transmission to date to the server even though the communication sensitivity is less than the reference value.

7. The metering data remote collection unit according to claim 1, wherein the second time interval is n (n is an integer of two or more) times the first time interval.
